(19) United States
(12) Patent Application Publication
(10) Pub. No.: US 2024/0093114 A1
(43) Pub. Date: Mar. 21, 2024

(54) CHEMISORBED LUBRICANTS FOR DATA STORAGE DEVICES

(71) Applicant: Western Digital Technologies, Inc., San Jose, CA (US)

(72) Inventors: Xingliang He, Fremont, CA (US); Huaming Xu, Santa Clara, CA (US); Jianming Wen, Pleasanton, CA (US); Charles Cheng-Hsing Lee, San Jose, CA (US)

(21) Appl. No.: 18/204,270

(22) Filed: May 31, 2023

Related U.S. Application Data
(60) Provisional application No. 63/398,666, filed on Aug. 17, 2022.

(51) Int. Cl. C10M 107/48; C10M 107/50; G11B 5/72; G11B 5/725

(52) U.S. Cl. CPC C10M 107/48; C10M 107/50; G11B 5/7257; G11B 5/7266; C10N 2040/18

(57) ABSTRACT

A lubricant adheres to a magnetic recording medium via at least one of chemisorption or bonding, and contains a perfluorinated polyether attached to or terminated with a functional group that is phosphonic acid, silanol or carboxylic acid, and may be:

R₁—R_{f}—R₁
where R_{f} is —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂—, n, m is from 1 to 100 and R₁ is the functional group. A lubricant is formed from a multiple ether segments according to formula:

Re¹—Rb¹-Ri-Rc-Ri-Rb²—Re²;
where Rc includes perfluoroalkyl ether, Rb¹ and Rb² are, independently, a sidechain segment including a perfluoroalkyl ether, optional Ri independently is a divalent linking segment including a functional group including elements from periodic table Group 13-17, and of Re¹ and Re² are phosphonic acid, silanol or carboxylic acid. Lubricant synthesis includes reacting a perfluorinated polyether with a halogenated functional group, selected from phosphonic acid, silanol or carboxylic acid.

### CROSS-REFERENCE TO RELATED APPLICATIONS

This application claims priority to and the benefit of U.S. Provisional Patent Application No. 63/398,666, filed on Aug. 17, 2022 entitled, “CHEMISORBED LUBRICANTS FOR DATA STORAGE DEVICES,” the entire content of which is incorporated herein by reference.

### FIELD

The disclosure is directed to lubricants, and more particularly, to lubricants having moieties bondable to an overcoat or outer layer of a magnetic recording layer structure, where the lubricants are suitable for use in various applications, including magnetic recording media.

### INTRODUCTION

The disclosure relates to lubricants suitable for use in magnetic storage media, and in particular, media configured for high energy recording such as heat assisted magnetic recording (HAMR), energy assisted magnetic recording (EAMR) or microwave assisted magnetic recording (MAMR). Magnetic storage systems, such as hard disk drive (HDD) systems, are utilized in a wide variety of devices in both stationary and mobile computing environments. Examples of devices that incorporate magnetic storage systems include data center storage systems, desktop computers, portable notebook computers, portable hard disk drives, network storage systems, high definition television (HDTV) receivers, vehicle control systems, cellular or mobile telephones, television set top boxes, digital cameras, digital video cameras, video game consoles, and portable media players.

A typical disk drive includes magnetic storage media in the form of one or more flat disks or platters. The disks are generally formed of two main components, namely, a substrate material that gives it structure and rigidity, and a magnetic media coating that holds the magnetic impulses or moments that represent data in a recording layer within the coating. The typical disk drive also includes a read head and a write head, generally in the form of a magnetic transducer which can sense and/or change the magnetic fields stored on the recording layer of the disks. High energy recording techniques such as HAMR increase the areal density (AD) of written data on a magnetic storage medium having high coercivity using high recording temperatures to write information to the medium. However, the high recording energy, microwaves or temperatures applied to the media may present challenges. Other examples of magnetic storage media include flexible tape media usable for magnetic tape recording.

One challenge arises from the layer of lubricant that separates the outer layer of the disk from the recording head. The separation of the slider (e.g., encompassing the recording head) from the disk is often less than 10 nm. As such, the lubricant often must be ultra-low profile. However, as the molecular weight of the lubricant backbone is reduced to a range of 100 to 1,000 Da for gaining the magnetic spacing and for decreasing head-disk clearance, the vapor pressure of the lubricant molecules increases exponentially. This will significantly increase desorption rate of the molecules and lubricant loss risk, ultimately resulting in the great instability of a sub-monolayer thick lubricant film.

That is, it is desired that the lubricant stay bonded on the disk stably and not be effortlessly evaporated into the environment of the HDD. Such media lubricant loss and/or the film stability degradation will endanger reliability, quality, and endurance of the component integrations of disk media with the head, thereby reducing overall performance of the actual HDD products. In addition, loss of the safeguard against disintegration of the necessary mechanical and chemical robustness, if the lubricant is disjoined from the disk surface, can cause the HDD to crash rapidly.

There is thus a need in the art to re-engineer lubricant designs having specific properties suitable for utilization in HDDs and specifically in magnetic recording media and to meet head-disk spacing reduction requirements without loss of lubricant film stability and the corresponding HDD product chemical/mechanical robustness. This new concept for designing the ultra-low-profile media lubricant is thus required with a focus on greatly strengthening surface adsorption of the lubricant molecules on disk overcoats.

### SUMMARY

In one aspect, the disclosure provides a lubricant configured to be adsorbed by a magnetic recording medium, including a perfluorinated polyether terminated with a functional group, where the functional group is capable of at least one of chemisorption or chemical bonding, and the functional group is at least one of phosphonic acid, silanol or carboxylic acid. The lubricant may have a structure:

R₁—R_{f}—R₁
where R_{f} is —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂—, etc., and m, n are independently from 1 to 100 and R₁ is the functional group. The lubricant may also have the structure:

R₁—R_{f}—R₁
where R_{f} is —CF₂O(CF₂CF₂O)ₙCF₂—, and n is independently from 1 to 100 and R₁ is the functional group.

In the disclosure, the functional group R₁ may have the structure:

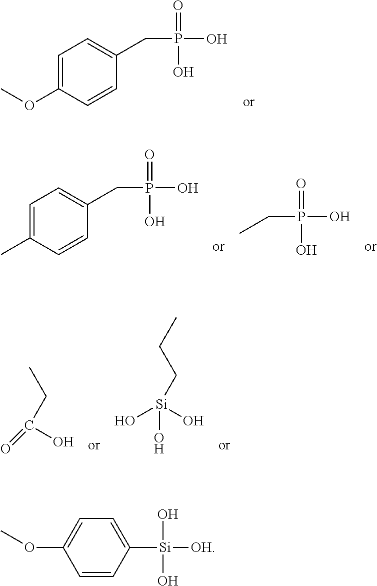

In one aspect, the disclosure provides a data storage device configured for magnetic recording, that includes:
a magnetic recording medium that includes:
   a substrate;
   a magnetic recording layer on the substrate; and
   an overcoat layer on the magnetic recording layer; and
the lubricant of the disclosure adhered to the overcoat layer. The lubricant may have a structure:

R₁—R_{f}—R₁
where R_{f} is CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙF₂—, —CF₂O(CF₂CF₂O)ₙCF₂— and m, n are independently from 1 to 100 and R₁ is a functional group. In an aspect, the lubricant may have a structure:

R₁—R_{f}—R₁
where R_{f} is —CF₂O(CF₂CF₂O)ₙCF₂—, n is from 1 to 100 and R₁ is a functional group.

In an aspect of the data storage device, The functional group may be:

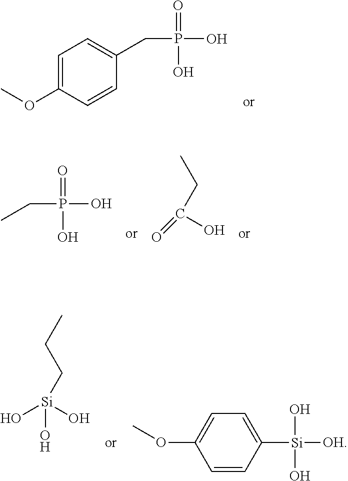

In one aspect, this disclosure also provides a data storage system, including: at least one magnetic head; a magnetic recording medium coated with a lubricant layer according one or more aspects disclosed herein; a drive mechanism for positioning the at least one magnetic head over the magnetic recording medium; and a controller electrically coupled to the at least one magnetic head for controlling operation of the at least one magnetic head.

In one aspect, this disclosure also provides a data storage system, including a slider comprising at least one magnetic head and an air bearing surface (ABS), where a lubricant thin film according one or more aspects disclosed herein is disposed on the ABS; and a magnetic recording medium including a magnetic recording layer; wherein the slider is configured to write information to the magnetic recording layer using heat assisted magnetic recording (HAMR), energy assisted magnetic recording (EAMR), or microwave assisted magnetic recording (MAMR).

In one aspect, this disclosure provides a lubricant including:
multiple segments each linked together by ether linkage according to a general formula:

Re¹—Rb¹-Ri-Rc-Ri-Rb²—Re²;
where Rc is a divalent center segment optionally including a perfluoroalkyl ether moiety;
where each of Rb¹ and Rb² is, independently, a sidechain segment including a perfluoroalkyl ether moiety;
where each Ri is optional, and independently may be a divalent linking segment including a functional group including elements from Group 13-17 of the periodic table of the elements; and
where each of Re¹ and Re² is, independently, a monovalent or multivalent end segment including a functional group including elements from Group 13-17 of the periodic table of the elements.

In the disclosure Re¹ and Re² are at least one of a phosphonic acid moiety, a silanol moiety or a carboxylic acid moiety.

In one aspect, the disclosure pertains to a method of synthesizing a lubricant that includes reacting a perfluorinated polyether with a halogenated functional group, where the functional group is phosphonic acid, silanol or carboxylic acid. The halogenated functional group may be (2-bromethyl)phosphonic acid or 4-bromobenzylphosphonic acid. The halogenated functional group may be diethyl 2-bromoethylphosphonate or diethyl(4-brombenzyl)phosphonate. The halogenated functional group may be (4-chlorophenyl)triethoxysilane or (4-bromphenyl)trimethoxysilane. The halogenated functional group may be a brominated carboxylic acid. The perfluorinated polyether may be CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100. The perfluorinated polyether may be —CF₂O(CF₂CF₂O)ₙCF₂—, and n is independently from 1 to 100.

Other aspects and advantages of the present invention will become apparent from the following detailed description, which, when taken in conjunction with the drawings, illustrate by way of example, the principles of the invention.

### BRIEF DESCRIPTION OF THE DRAWINGS

FIG. 1a is a diagram schematically illustrating a data storage device including a slider and a magnetic recording medium in accordance with one aspect of the disclosure;

FIG. 1b is a side schematic view of the slider and magnetic recording medium of FIG. 1a in accordance with one aspect of the disclosure;

FIG. 2 is a side schematic view of a magnetic recording medium configured, for example, for heat assisted magnetic recording and including a lubricant layer in accordance with one aspect of the disclosure;

FIG. 3 is a graph showing an exemplary relationship between vapor pressure and chain length of different alkane molecules;

FIG. 4 shows the molecular design concept of a lubricant according to an aspect of the disclosure;

FIG. 5 shows the bonding schematic of a phosphonated lubricant to a protective overcoat of a disk shaped magnetic recording medium for an HDD according to an aspect of the disclosure;

FIG. 6 shows the bonding schematic of a silanol lubricant to a protective overcoat of a disk shaped magnetic recording medium for an HDD according to an aspect of the disclosure; and

FIG. 7 shows the bonding schematic of a carboxylated lubricant to a protective overcoat of a disk shaped magnetic recording medium for an HDD according to an aspect of the disclosure.

### DETAILED DESCRIPTION

Heat Assisted Magnetic Recording (HAMR) systems operate at substantially higher temperatures than traditional magnetic recording systems, also referred to herein as conventional magnetic recording (CMR) systems which do not employ heat or other energy assisted recording. Examples of CMR systems may include perpendicular magnetic recording disk drives and flexible tape media usable for magnetic tape recording, which do not employ heat or other energy assisted recording. HAMR is an example of magnetic recording within the class of Energy Assisted Magnetic Recording (EAMR) techniques, where CMR is supplemented by other energy used in the system. Other examples of EAMR may include Microwave Assisted Magnetic Recording (MAMR) and applications of electric current into various conductive and/or magnetic structures near the main pole.

The thickness of a lubricant on the outer overcoat of a magnetic recording medium, for example a disk of a HDD, is less than 10 nm and ideally forms a chemisorbed or chemically bonded molecular layer. The lubricant plays a number of roles at the head-disk interface, including spacing/clearance establishment, chemical integration, contamination prevention, head wear reduction, head-disk interaction control, etc. Ideally, the lubricant film stays on the disk and does not migrate into the environment of the HDD. If it does migrate, the mechanical and chemical integrations of head and disks are changed and thereby performance is impacted. Loss of the protections of a lubricant film caused by highly volatile molecules can even result in head crash and ultimately the HDD to fail. When the organofluorine and/or hydrocarbon backbone chains have a molecular weight smaller than 2,000 or 3,000 Da, the vapor pressure increases exponentially, resulting in an increased likelihood of the lubricant film migrating away from the disk if surface adsorption of the molecules is not greatly strengthened.

This desorption/evaporation loss problem is addressed by increasing the active bonding sites of the overcoat layer of the disk and enhancing the chemisorption/chemical bonding functionality of the end groups of the lubricant. Where some lubricants may utilize single terminal hydroxyl groups to bond to the corresponding hydroxyl groups on the surface of the overcoat by physical bonds, aspects of the lubricants described herein may convert the physical bonding to chemical bonding. This approach has the effect of re-engineering of the bonding status of the lubricant adsorption to the overcoat.

Aspects of the lubricants described herein may terminate in functional groups selected from phosphonic acid, silanol or carboxylic acid. Phosphonic acid and silanol have 2 and 3 hydroxyl groups, respectively, at the bonding terminus of the lubricant to provide initial attachment to additional bonding sites on the overcoat. Furthermore, phosphonic acid, silanol, and carboxylic acid also have a higher degree of oxidation than hydroxyl, and will dehydrate in a certain circumstance, i.e., lose H₂O by natural bonding saturation, UV or heat treatment, readily when contacting the hydroxyl group of the overcoat of the magnetic recording media.

In an aspect of the disclosure, the lubricant has the structure:

R₁—R_{f}—R₁
where R_{f} is —CF₂O(CF₂CF₂CF₂CF₂O)ₙ—, —CF₂CF₂O(CF₂CF₂CF₂O)ₙCF₂CF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100, and R₁ is the functional group selected from phosphonic acid, silanol or carboxylic acid. Alternately, R_{f} may be —CF₂O(CF₂CF₂O)ₙCF₂— or —CF₂O(CF₂CF₂CF₂O)ₙCF₂—, where n is independently from 1 to 100 and R₁ is the functional group.

### Definitions

For purposes herein, and the claims thereto, the new numbering scheme for the Periodic Table Groups is used as described in Chemical and Engineering News, 63(5), pg. 27 (1985). Therefore, a “group 4 metal” is an element from group 4 of the Periodic Table, e.g. Hf, Ti, or Zr. For purposes herein, molecular weight refers to weight average molecular weight (Mw) and is expressed as grams per mole (g/mol) unless otherwise specified.

As used herein, and unless otherwise specified, the term “Cₙ” means hydrocarbon(s) or perfluorocarbon(s) having n carbon atom(s) per molecule, where n is a positive integer. Likewise, a “Cₘ-C_{y}” group or compound refers to a group or compound comprising carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

The term “moiety” refers to one or more covalently bonded atoms which form a part of a molecule. The terms “group,” “radical,” “moiety”, and “substituent” may be used interchangeably.

The terms “hydrocarbyl radical,” “hydrocarbyl group,” or “hydrocarbyl” may be used interchangeably and are defined to mean a group containing of hydrogen and carbon atoms only. Preferred hydrocarbyls are C₁-C₂₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

For purposes herein, a heteroatom is any non-carbon atom, selected from groups 13 through 17 of the periodic table of the elements. In one or more aspects, heteroatoms are non-metallic atoms selected from B, N, O, Si, P, S, As Se, Te and the halogens F, Cl, Br, I, and At.

Unless otherwise indicated, the term “substituted” means that at least one hydrogen atom has been replaced with at least one non-hydrogen atom or a functional group.

For purposes herein, a functional group includes one or more of Si(OH)₃, PO(OH)₂, COOH, a hydrocarbyl group, a heteroatom, or a heteroatom containing group, such as halogen (such as Br, Cl, F or I) or at least one functional group such as —NR*₂, —NR*—CO—R*,—OR*,*—O—CO—R*, —CO—O—R*, —SeR*, —TeR*, —PR*₂, —PO—(OR*)₂, —O—PO—(OR*)₂, —AsR*₂, —SbR*₂, —SR*, —SO₂—(OR*)₂, —BR*₂, —SiR*₃, —(CH₂)q-SiR*₃, or a combination thereof, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure, or where at least one heteroatom has been inserted within a hydrocarbyl ring.

In one or more aspects, functional groups may include: a saturated C₁-C₂₀ radical, an unsaturated C₁-C₂₀ radical, an alicyclic C₃-C₂₀ radical, a heterocyclic C₃-C₂₀ radical, an aromatic C₅-C₂₀ radical, a heteroaromatic C₅-C₂₀ radical, a cyclotriphosphazine radical, a halogen, —NR*₂, —NR*—CO—R*,—OR*,—O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)q- SiR*₃, —(CF₂)q-SiR*₃, or a combination thereof, where q is 1 to 10 and each R* is, independently a hydrogen, a halogen, a saturated, unsaturated, aromatic, and/or heterocyclic C₁-C₂₀ radical.

For purposes herein, a functional group, which is attachable to a surface of a magnetic recording medium, refers to functional groups having entirely changed affinity for that surface relative to the affinity of perfluoroalkyl ethers to that same surface. The completely different affinity may include chemical bonding and chemisorption beyond conventional physical bonding, like hydrogen bonds, Van der Waals forces, weak London Dispersion forces, dipole-dipole interaction, and/or the like, and/or one or more types of bonds and/or dative bonds with the surface of the magnetic recording media, preferably with a protective overcoat of a recording media. In one or more aspects, a functional group which is attachable to a surface of a magnetic recording medium refers to functional groups having enabled affinity in a chemical way for the carbon overcoat (COC) layer of the magnetic recording media, relative to the affinity of perfluoroalkyl ethers to that same surface.

A heterocyclic ring, also referred to herein as a heterocyclic radical, is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring is a heterocyclic ring where a hydrogen of one of the ring atoms is substituted, e.g., replaced with a hydrocarbyl, or a heteroatom containing group.

A “compound” refers to a substance that is composed of two or more separate chemical elements. A “derivative” refers to a compound in which one or more of the atoms or functional groups of a precursor compound have been replaced by another atom or functional group, generally by means of a chemical reaction having one or more steps.

For purposes herein, unless otherwise specified, the media lubricants include a plurality of segments and each segment is attached to the other segment by an ether bond, e.g., a —C—O—C— linkage. For purposes herein, a segment including a perfluoropolyalkyl ether moiety may have the general formula:

—(CF₂)ₐO—;
where each a is from 1 to 100. A segment including a perfluoroalkyl ether moiety has the general formula:

—(CF₂)ₐO)_{b}—;
where each a is from 1 to 100 and b is the number of repeating units in the segment.

The perfluoroalkyl ether moieties present in a particular segment are bonded together to form a perfluoropolyalkyl ether chain. Unless indicated otherwise, each of the perfluoroalkyl ether moieties present in a perfluoropolyalkyl ether segment may be the same or different. For example, the following are each examples of a perfluoropolyalkyl ether segments:
i) —(CF₂CF₂O)_{b}—, a perfluoropolyethylether segment;
ii) —(CF₂CF₂CF₂O)_{b}—, a perfluoropolypropylether segment;
iii) —CF(CF₃)CF₂O)_{b}—, a perfluoropolybutylether segment;
iv) —(CF₂CF₂CF₂CF₂O)_{b}—, a perfluoropolybutylether segment; and
v) —(CF₂CF₂O)_{b}—(CF₂O)_{b′}—, a perfluoropolyethylether-perfluoropolymethylether segment, also referred to in the art as a Z-chain segment.

For purposes herein, the molecular weight of a segment, e.g., a divalent center segment including a perfluoroalkyl ether moiety Rc and/or a divalent sidechain segment including a perfluoroalkyl ether moiety Rb¹ and Rb² is defined as the molecular weight of the perfluoroalkyl ether moieties present in the segment.

Unless otherwise indicated, a divalent center segment, abbreviated Rc herein, refers to a divalent chemical moiety optionally including a perfluoroalkyl ether moiety, or optionally which is formed from one or more perfluoroalkyl ether moieties, that is chemically bonded via an ether linkage to a linking segment moieties on either side.

An intermediate or linking segment, abbreviated as Ri herein, refers to a chemical moiety bonded between the center segment and a sidechain segment by an ether linkage, and which includes at least one functional group, which is preferably selected to attached to the protective layer of the magnetic recording media.

A side chain segment, abbreviated Rb herein, refers to a divalent chemical moiety including a perfluoroalkyl ether moiety, or formed from one or more perfluoroalkyl ether moieties, that is chemically bonded via an ether linkage to a linking segment moiety and an end segment.

An end segment, abbreviated Re herein, refers to a mono-valent radical which includes at least one functional group preferably selected to attach to the protective layer of the magnetic recording media. The end moieties are located at either end of a sidechain of the lubricant molecule.

For any particular compound disclosed herein, any general or specific structure presented also encompasses all conformational isomers, regio-isomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

As used herein, a moiety which is chemically identical to another moiety is defined as being identical in overall composition exclusive of isotopic abundance and/or distribution, and/or exclusive of stereochemical arrangement such as optical isomers, conformational isomers, spatial isomers, and/or the like.

### Data Storage Device

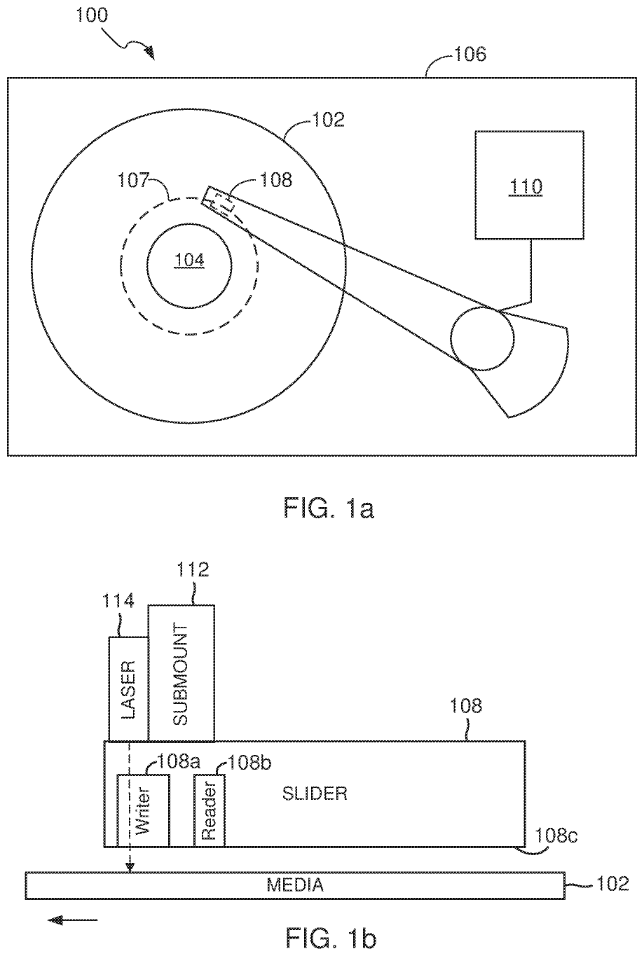

FIG. 1a is a top schematic view of a data storage device 100 (e.g., disk drive or magnetic recording device) configured for magnetic recording including a slider 108 and a magnetic recording medium or disk 102 having a lubricant layer according to one or more aspects of the disclosure. The laser (not visible in FIG. 1a but see 114 in FIG. 1b) specifically used for heat-assisted magnetic recording (HAMR) is positioned with a head/slider 108. The disk drive 100 may include one or more disks/media 102 to store data. Disk/media 102 resides on a spindle assembly 104 that is mounted to a drive housing. Data may be stored along tracks in the magnetic recording layer of disk 102. The reading and writing of data is accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR), giant magneto-resistive (GMR), or tunnel magneto-resistive (TMR) elements. In an alternative aspect, head 108 may be another type of head, for example, a Hall effect head. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). Note that while an example HAMR system is shown, the various embodiments described may be used in other EAMR or non-EAMR magnetic data recording systems, including perpendicular magnetic recording (PMR) disk drives or magnetic tape drives.

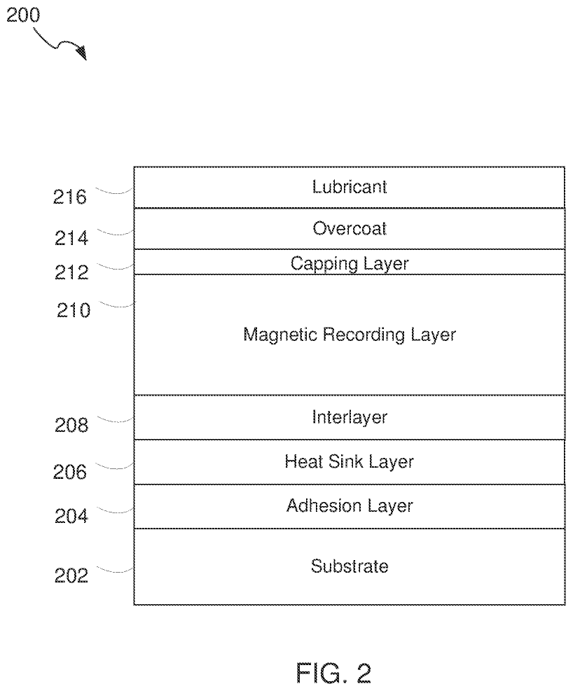

FIG. 1b is a side schematic view of the slider 108 and magnetic recording medium 102 of FIG. 1a, configured for HAMR. The magnetic recording medium 102 includes a lubricant layer (see FIG. 2) in accordance with one or more aspects of the disclosure. The slider 108 may include a sub-mount 112 attached to a top surface of the slider 108. The laser 114 may be attached to the sub-mount 112, and possibly to the slider 108. The slider 108 includes a write element (e.g., writer) 108a and a read element (e.g., reader) 108b positioned along an air bearing surface (ABS) 108c of the slider for writing information to, and reading information from, respectively, the media 102.

In operation, the laser 114 used in HAMR is configured to generate and direct light energy to a waveguide (e.g., along the dashed line) in the slider which directs the light to a near field transducer (NFT) near the air bearing surface (e.g., bottom surface) 108c of the slider 108. Upon receiving the light from the laser 114 via the waveguide, the NFT generates localized heat energy that heats a portion of the media 102 within or near the write element 108a, and near the read element 108b. The anticipated recording temperature is in the range of about 350° C. to 400° C. In the aspect illustrated in FIG. 1B, the laser directed light is disposed within the writer 108a and near a trailing edge of the slider. In other aspects, the laser directed light may instead be positioned between the writer 108a and the reader 108b. FIG. 1b illustrates a specific example of a HAMR system. In other examples, the magnetic recording medium 102 with the lubricant layer according to aspects of the disclosure can be used in other suitable HAMR systems (e.g., with other sliders configured for HAMR). The technology can also be used in EAMR and MAMR systems, or in non-HAMR systems.

### Magnetic Recording Medium

FIG. 2 is a side schematic view of a magnetic recording medium 200 configured, for example, for heat assisted magnetic recording and having a lubricant layer according to one or more aspects of the disclosure. In one aspect, the magnetic recording medium 200 may be used in a data storage system configured for HAMR, EAMR, or MAMR (e.g., disk drive 100). The magnetic recording medium 200 has a stacked structure with a substrate 202 at a bottom/base layer, an adhesion layer 204 on the substrate 202, a heat sink layer 206 on the adhesion layer 204, an interlayer 208 on the heat sink layer 206, a magnetic recording layer (MRL) 210 on the interlayer 208, a capping layer 212 on the MRL 210, an overcoat layer 214 on the capping layer 212, and a lubricant layer 216 on the overcoat layer 214. In one aspect, the magnetic recording medium 200 may have a soft magnetic underlayer (SUL) between the adhesion layer 204 and the heat sink layer 206. In one aspect, the magnetic recording medium 200 may have a thermal resistance layer (TRL) between the interlayer 208 and the heat sink layer 206. Some of the layers such as TRL and heat sink layer may be absent or substituted with different layers in a non-HAMR recording medium. In one aspect, the substrate 202 can be made of one or more materials such as an Al alloy, NiP plated Al, glass, glass ceramic, and/or combinations thereof. In some aspects, the magnetic recording medium 200 may have some or all of the layers illustrated in FIG. 2 and/or additional layer(s) in various stacking orders. It should also be noted that each layer shown in FIG. 2 may include one or more sub-layers. For example, the magnetic recording layer may have multiple layers in certain embodiments.

### Lubricants

In one aspect, lubricants disclosed herein may function as a lubricating molecular layer which may be used in various mechanical devices, including data storage systems configured for magnetic recording (e.g., hard disk drives or tape drives) and other microelectronic mechanical systems. The polymeric or macromolecular lubricants may form a lubricant layer when one or more functional groups of the lubricant adsorb or otherwise couple with the surface being lubricated. For instance, a lubricant layer 216 is formed on an overcoat layer 214 of a magnetic recording medium 200 (e.g. a disk that includes a magnetic recording layer 210) that moves relative to other parts in the mechanical device. This lubricant layer 216 helps to protect the magnetic recording medium from friction, wear, contaminations, and/or damage caused by interactions between the magnetic recording medium and other parts in the mechanical device (e.g., interactions, such as contact, attrition, abrasion, erosion between a slider and the magnetic recording medium in a certain circumstance). In other words, this interfacial polymeric and/or molecular layer helps enable reliable, robust, and endurant chemical/mechanical integrations of the magnetic recording medium with the write/read heads (e.g., such as those contained in slider 108 of FIG. 1b).

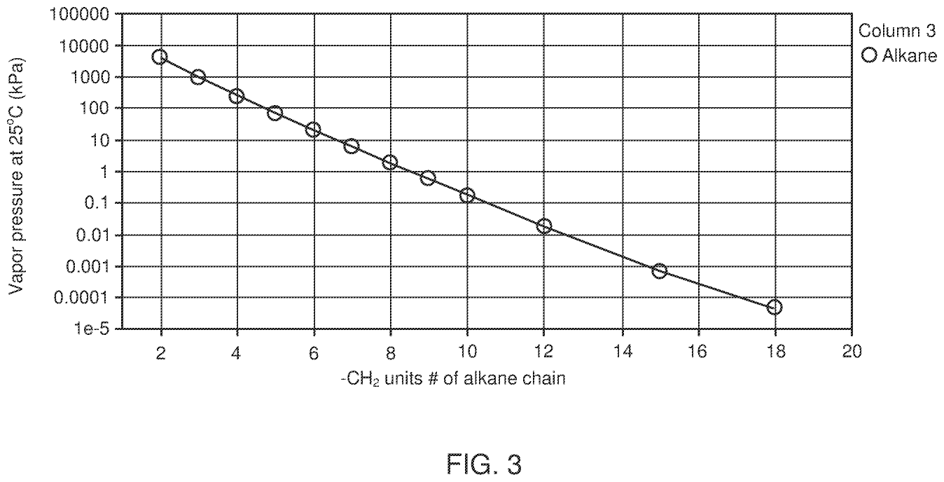

FIG. 3 is a graph showing an exemplary relationship between vapor pressure and chain length of different alkane molecules [e.g. methane (CH₄), ethane (C₂H₆), propane (C₃H₈), butane (C₄H₁₀), pentane (C₅H₁₂), hexane (C₆H₁₄), heptane (C₇H₁₆), octane (C₈H₁₈), nonane (C₉H₂₀), decane (C₁₀H₂₂), dodecane (C₁₂H₂₆), pentadecane (C₁₅H₃₂), and octadecane (C₁₈H₃₈)] that is relevant to an aspect of the disclosure. FIG. 3 shows the vapor pressure at 25°C. as a function of the number of —CH₂ repeating units of the alkane chains. As can be seen, there is an exponential decrease in the vapor pressure as the chain length increases. On the other hand, there is a dramatic increase in vapor pressure as length of the alkane chain is reduced. In general, vapor pressure of fluorocarbon molecules can be higher than hydrocarbon molecules. As a result, when shorter perfluoroalkyl ether chains are used for designs of media lubricant molecules, this significantly increased vapor pressure will promote loss of lubricant coverage/protections, dewetting/film rupture, and other disadvantageous mechanical/chemical intergration effects. The lubricants of the disclosure address this problem by prompting different surface physics via introductions of chemisorption and/or chemical bonds beyond the conventional physical bonds on the overcoat of the magnetic recording media.

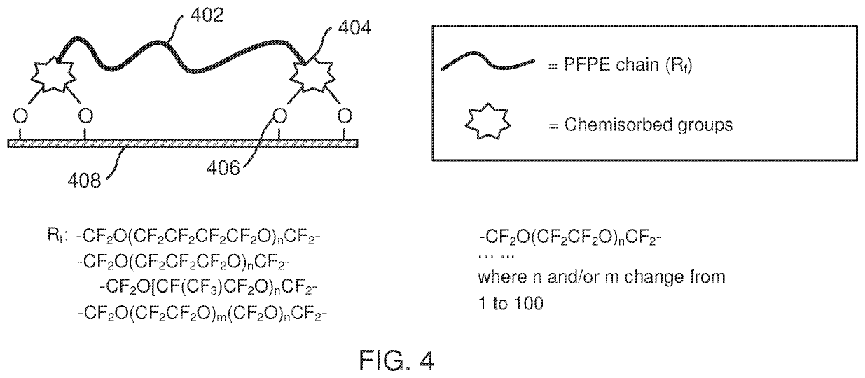

FIG. 4 shows the molecular design according to an embodiment of the disclosure. The molecular design includes a perfluorinated polyether (PFPE) chain (R_{f}) 402 where R_{f} may be —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100. The PFPE chain (R_{f}) 402 terminates in chemisorbed groups 404 which may be selected from phosphonic acid, silanol or carboxylic acid. The chemisorbed groups 404 are bonded to an overcoat layer 214 over a substrate of a magnetic recording medium 200, 408 via an oxygen moiety 406. This molecular film design greatly strengthens absorption to produce ultra-low-profile and/or short backbone lubricant layers. That is, the bonding of the lubricant molecules to the recording media surface is achieved using chemical bonding by e.g., phosphonic acid, silanol or carboxylic acid to yield a bonding ratio of about 100% that produces stabilized absorption even at high temperatures accompanied by greatly enhanced film stability and reduced lubricant depletion. The chemisorbed or chemically reacted phosphonate/silane/carboxyl-terminated self-assembled monolayer (SAM)-like interface can also yield oxidation/corrosion inhibition while compensating possibly poor coverage when the carbon overcoat (COC) <10 nm. That is, surface passivation yields more comprehensive improvements on chemical and contamination robustness.

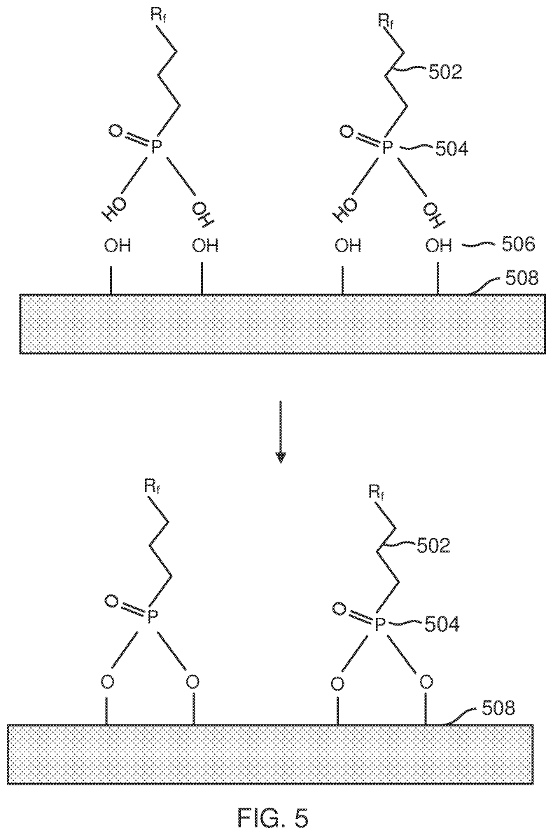

FIG. 5 shows the bonding schematic of a lubricant 502 formed from a perfluorinated polyether (PEPE) with a phosphonic acid end group 504 captured by the —OH moieties 506 of an overcoat 508 of a magnetic recording media. An esterification reaction bonds the divalent end of the phosphonic acid much more strongly to the overcoat than the conventional hydrogen bond Van der Waals forces, weak London Dispersion forces, dipole-dipole interaction, etc. of the art. An exemplary structure of the lubricant can be shown as:

(HO)₂O═P—R_{f}—P═O(OH)₂
where R_{f} is —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100.

One form of the phosphonic end group can take is:

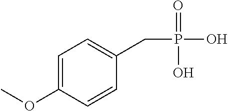

where the inclusion of the benzene ring promotes higher thermal stability, better coverage and an enhanced molecular conformation. The aromatic ring is not restricted to benzene and other aromatic substituents can be used, e.g., naphthalene, anthracene, phenanathrene, pyrene, etc. Other configurations can be non-aromatic in nature:

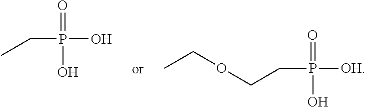

There are alternative pathways to synthesize lubricant with phosphonic acid end groups. One exemplary route would be to run a substitution reaction of a perfluorinated polyether with a brominated phosphonic acid:

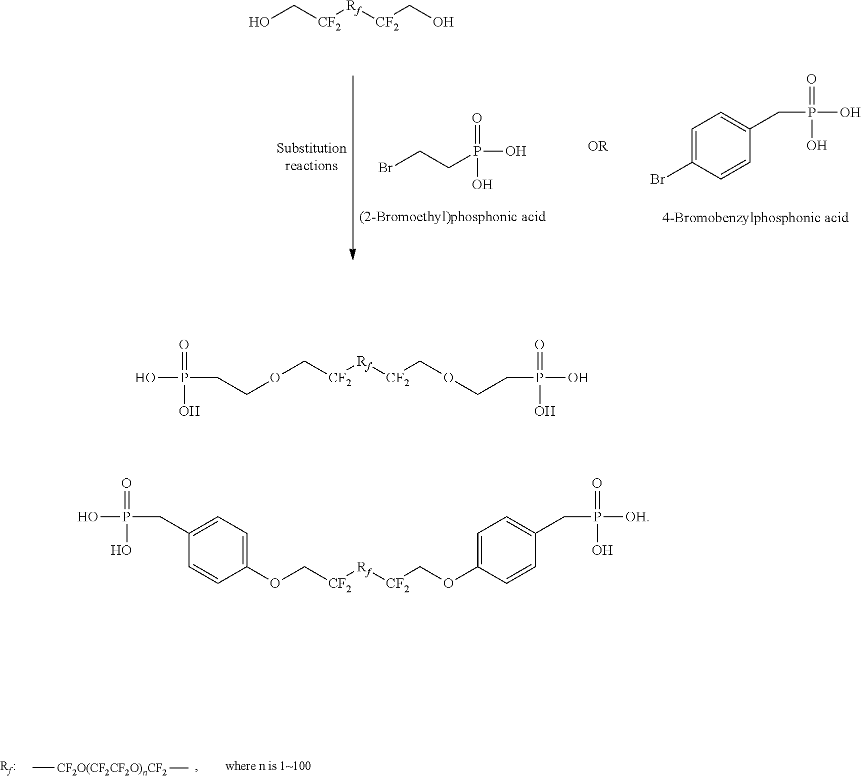

Another exemplary synthetic route would be to react a perfluorinated polyether with a brominated phosphonate followed by hydrolysis to yield the phosphonated polyether:

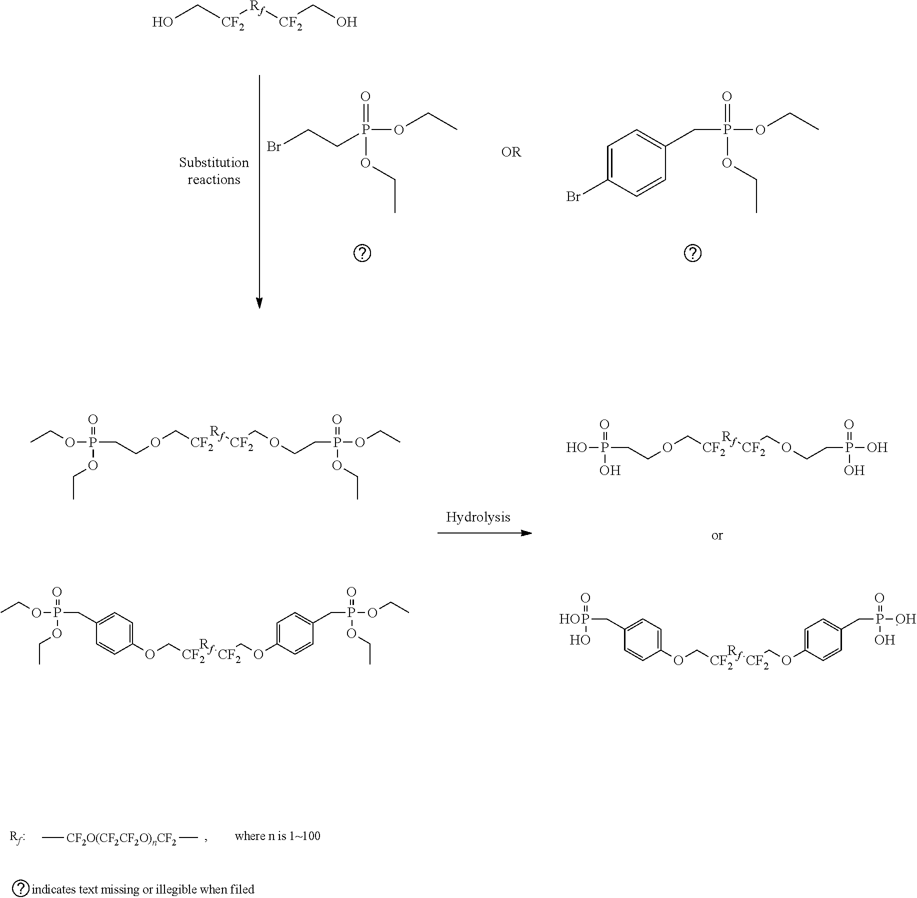

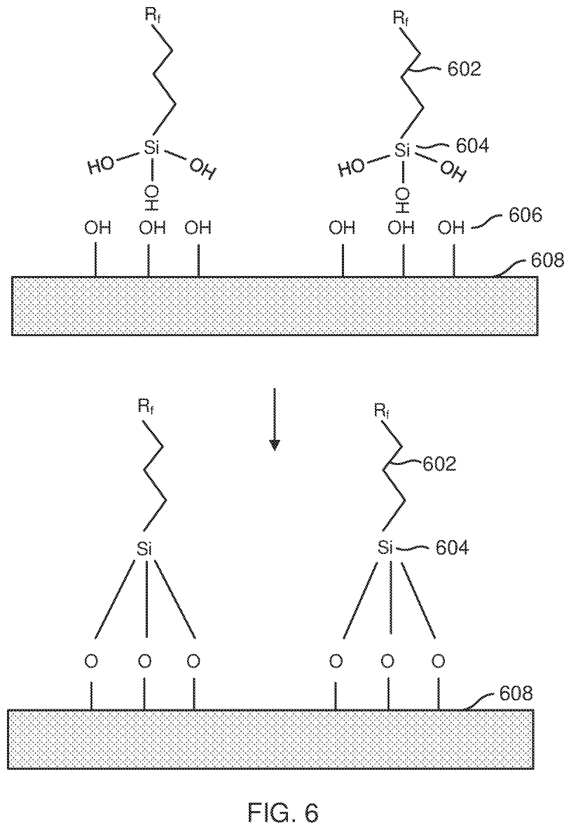

FIG. 6 shows the bonding schematic of a lubricant 602 formed from a perfluorinated polyether (PFPE) R_{f} with a silanol end group 604 bonding with the —OH moieties 606 of an overcoat 608 of a magnetic recording media. The triple chemical bond with the Si atom yields very strong adhesion to the magnetic recording medium surface.

The silanol functional group can be either straight chain or associated with aromatic rings:

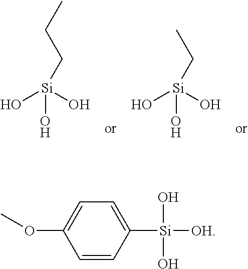

This silonated polyether can be synthesized using a substitution reaction with a halogenated silane with a perfluorinated polyether:

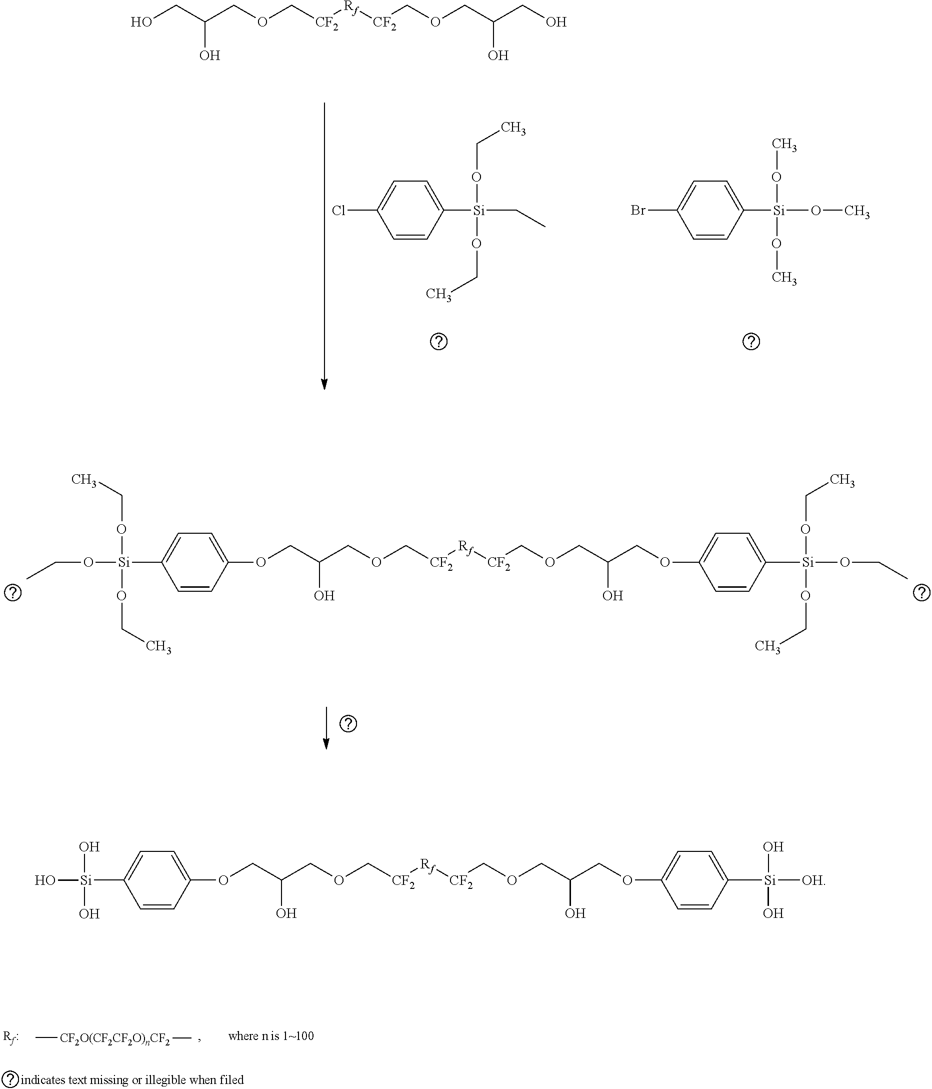

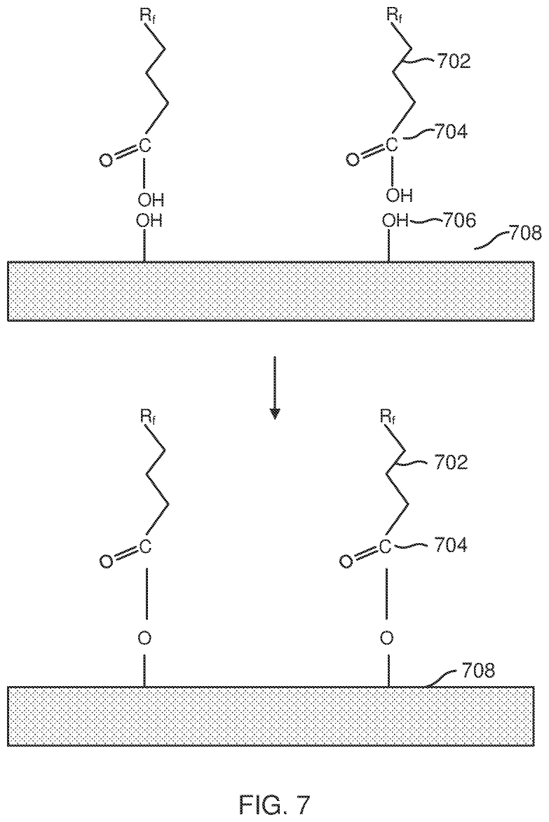

FIG. 7 shows the bonding schematic of a carboxylated lubricant to a protective overcoat of a disk configured for magnetic recording according to an aspect of the disclosure. In FIG. 7, a lubricant 702 formed from a perfluorinated polyether (PFPE) R_{f} with a carboxylic end group 704 bonds chemically with the —OH moieties 706 on the overcoat 708 of a HDD disk.

In the disclosure, the functional group can be a carboxylic acid having the formula —(CH₂)ₙ—COOH in the formula HOOC—(CH₂)ₐ—R—(CH₂)ₐ—COOH where a is from 1 to 20 and R is —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100. The molecule can be synthesized by reacting a perfluorinated polyether with a halogenated carboxylic acid:

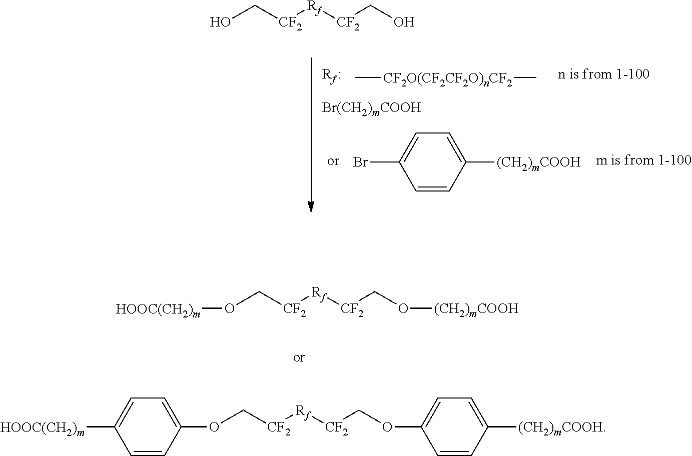

Another exemplary media lubricant includes a plurality of segments, each linked together through an ether linkage according to a general formula:

Re¹—Rb¹—Ri-Rc-Ri-Rb²—Re²;
where Rc is a divalent center segment including a perfluoroalkyl ether moiety; Rb¹ is a first sidechain segment, Rb² is a second sidechain segment, each independently includes a perfluoroalkyl ether moiety; each Ri segment is, independently, a divalent linking segment including a functional group including elements from Group 13-17 of the periodic table of the elements, which in this aspect are hydroxyl groups (—OH). Re¹ is a first end segment and Re² is a second end segment, each is a monovalent or divalent end segment selected from a phosphonic acid moiety, a silanol moiety or a carboxylic acid moiety. In this aspect, each of the sidechain segments includes a perfluoroethyl ether moiety —(CF₂CF₂O)_{b}— where b is 6, e.g., b¹ and b² and the center segment includes a perfluoroethyl ether moiety —(CF₂CF₂O)_{b}— where b is 2, e.g., b³. Each of the linking segments includes a hydroxyl functional group, along with the end groups Re¹ and Re², which are selected for the ability to attach to the surface of the carbon overcoat of the recording media, due in part to being highly polar or chemisorption moieties.

Another exemplary boundary lubricant includes a plurality of segments, each linked together through an ether linkage according to a general formula:

Re¹—Rb¹-Ri-Rc-Ri-Rb²—Re²;
where Rc is a divalent center segment including a perfluoroalkyl ether moiety; Rb¹ is a first sidechain segment, Rb² is a second sidechain segment, each independently includes a perfluoroalkyl ether moiety; each Ri segment is, independently, a divalent linking segment including a functional group including elements from Group 13-17 of the periodic table of the elements, which in this aspect are hydroxyl groups (—OH). Re¹ is a first end segment and Re² is second end segment, each is a monovalent or divalent end selected from a phosphonic acid moiety, a silanol moiety or a carboxylic acid moiety In this aspect of the disclosure, Rb¹≠Rc≠Rb², and Rb¹═Rb².

In this aspect, each of the sidechain segments includes a perfluoroethyl ether moiety —(CF₂CF₂O)_{b}— where b is 2, e.g., b¹ and b², and the center segment includes a perfluoroethyl ether moiety —(CF₂CF₂O)_{b}— where b is 6, e.g., b³.

In various aspects, the lubricant layer can be formed on the magnetic recording medium, specifically on the protective overcoat, via a dip coating method. For instance, in one aspect the magnetic recording medium may be dipped into a lubricant bath including the perfluorinated polyether (PFPE)-based lubricant according to one or more aspects of the disclosure and a specialty solvent such as VERTREL-XF (1,1,1,2,3,4,4,5,5,5-decafluoropentane). After a predetermined amount of time, the magnetic recording medium may be removed from the lubricant bath at a controlled rate. The solvent then evaporates, leaving behind a lubricant layer comprising the molecular-thin lubricant according to one aspect of the disclosure. The percentage of the lubricant remaining on the surface of the magnetic recording medium after disposition of the lubricant may be referred to as the bonded percentage or the bonding percentage. The bonding percentage may be quantified for various time periods by exposing the lubricated magnetic recording medium with the solvent used in the lubricant bath.

In one aspect, the thickness of the lubricant layer may be tuned by controlling the submergence duration of the magnetic recording medium in the lubricant bath, the rate at which the magnetic recording medium is removed from the coating solution, and/or the concentration of the lubricant in the lubricant bath.

In one or more aspects, the concentration of lubricant in the lubricant bath may be in a range from about 0.001 g/L to about 10 g/L. In yet other aspects, the concentration of the lubricant in the lubricant bath may be selected so as to achieve a resulting lubricant layer with a thickness down to the nanometer level.

One should note that formation of the lubricant layer on the surface of the magnetic recording medium, specifically on the surface of the protective overcoat, is not limited to dip coating, but may also involve spin coating, spray coating, a vapor deposition, combinations thereof, or any other suitable coating process as would be understood by one having skill in the art upon reading the present disclosure. In addition, the magnetic recording layer, the protective overcoat, and/or any of the other layers of the media (e.g., including each of the layers shown for media 200 in FIG. 2) may be formed using any of numerous deposition methods that are known in the art.

Note that methodology presented herein for at least some of the various aspects may be implemented, in whole or in part, in computer hardware, by hand, using specialty equipment, and/or the like, and combinations thereof.

Moreover, any of the structures and/or steps may be implemented using known materials and/or techniques, as would become apparent to one skilled in the art upon reading the disclosure.

The above description is made for the purpose of illustrating the general principles of the present disclosure and is not meant to limit the inventive concepts claimed herein. Further, particular features described herein can be used in combination with other described features in each of the various possible combinations and permutations.

It should be noted that in the development of any such actual aspect, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the device, system and/or method used/disclosed herein can also include some components other than those cited.

Unless otherwise specifically defined herein, all terms are to be given their broadest possible interpretation including meanings implied from the specification as well as meanings understood by those skilled in the art and/or as defined in dictionaries, treatises, and the like.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 20% of the reference value. For example, a thickness of about 10 nm refers to a thickness of 10 nm+/−2 nm, e.g., from (0.8 nm to 1.2 nm in this example.

In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.” The term “and/or” refers to both the inclusive “and” case and the exclusive “or” case, and such term is used herein for brevity. For example, a composition formed from “A and/or B” may be A alone, B alone, or both A and B.

Various components described in this specification may be described as “including” and/or made of, and/or “having” certain materials, properties, or compositions of material(s). In one aspect, this can mean that the component has certain materials, properties, or compositions of materials. In another aspect, this can mean that the component has certain materials, properties, or compositions of material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other.

It is further noted that the term “over” and/or the term “on” as used in the disclosure in the context of one component located over another component, or in the context of one component located on another component, may be used to mean a component that is directly on a surface of another component e.g., disposed in physical contact with the surface of the other component, and/or in another component, e.g., directly embedded in a component. Thus, for example, a first component that is over or on the second component may mean that (1) the first component is located over or above the second component, but not directly touching the second component, (2) the first component is directly on (e.g., directly on a surface of) the second component, and/or (3) the first component is in (e.g., embedded in) the second component.

In the disclosure various ranges in values may be specified, described and/or claimed. It is noted that any time a range is specified, described and/or claimed in the specification and/or claim, it is meant to include the endpoints (at least in one aspect). In another aspect, the range may not include the endpoints of the range. In the disclosure various values (e.g., value X) may be specified, described and/or claimed. In one aspect, it should be understood that the value X may be exactly equal to X. In one aspect, it should be understood that the value X may be “about X,” with the meaning noted above. Likewise, when a value is determined according to an equation, it is to be understood that in one aspect, the value is equal to the value calculated according to the equation and in another aspect, the value is about equal to the value calculated according to the equation according to the meaning noted above, or as is expressly provided for, e.g., plus or minus (+/−) a specific amount.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

What is claimed is:

1. A lubricant configured to be adsorbed by a magnetic recording medium, comprising:
a perfluorinated polyether terminated with a functional group,
wherein the functional group is capable of at least one of chemisorption or chemical bonding, and the functional group comprises at least one of phosphoric acid, silanol or carboxylic acid.

2. The lubricant of claim 1, wherein the lubricant has a structure:
R₁—R_{f}—R₁
where R_{f} is —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100 and R₁ is the functional group.

3. The lubricant of claim 1, wherein the lubricant has a structure:
R₁—R_{f}—R₁
where R_{f} is —CF₂O(CF₂CF₂O)ₙCF₂—, and n is independently from 1 to 100 and R₁ is the functional group.

4. The lubricant of claim 1, where the functional group comprises:

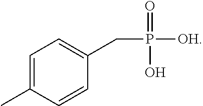

5. The lubricant of claim 1, where the functional group comprises:

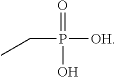

6. The lubricant of claim 1, wherein the functional group comprises:

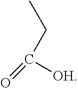

7. The lubricant of claim 1, wherein the functional group comprises:

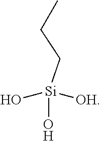

8. The lubricant of claim 1, wherein the functional group comprises:

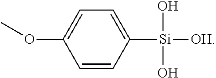

9. A magnetic recording medium comprising:
a substrate;
a magnetic recording layer on the substrate; and
an overcoat layer on the magnetic recording layer; and
the lubricant of claim 1 adhered to the overcoat layer.

10. A data storage device configured for magnetic recording, comprising:
at least one magnetic head;
the magnetic recording medium according to claim 9;
a drive mechanism for positioning the at least one magnetic head over the magnetic recording medium; and
a controller electrically coupled to the at least one magnetic head for controlling operation of the at least one magnetic head.

11. The data storage device of claim 10, wherein the lubricant has a structure:
R₁—R_{f}—R₁
where R_{f} is —CF₂O(CF₂CF₂O)nCF₂—, n is from 1 to 100 and R₁ is a functional group.

12. The data storage device of claim 10, wherein the lubricant has a structure:
R₁—R_{f}—R₁
where R_{f} is —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100 and R₁ is a functional group.

13. The data storage device of claim 12, wherein the functional group comprises:

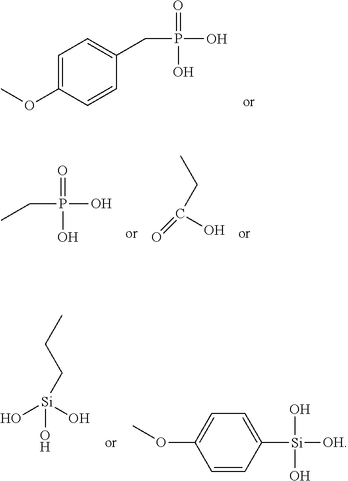

14. A data storge system, comprising:
a slider comprising at least one magnetic head and an air bearing surface, wherein a thin film of the lubricant according to claim 1 is disposed on the air bearing surface; and
a magnetic recording medium including a magnetic recording layer;
wherein the slider is configured to write information to the magnetic recording layer using at least one of: heat assisted magnetic recording, energy assisted magnetic recording, or microwave assisted magnetic recording.

15. A lubricant comprising:
a plurality of segments, each linked together by ether linkages according to a general formula:
Re¹—Rb¹-Ri-Rc-Ri-Rb²—Re²;
wherein Rc is a divalent center segment including a perfluoroalkyl ether moiety;
wherein each of Rb¹ and Rb² is, independently, a sidechain segment including a perfluoroalkyl ether moiety;
wherein each Ri is optional, and independently is a divalent linking segment including a functional group including elements from Group 13-17 of the periodic table of the elements; and
wherein each of Re¹ and Re² is a functional group comprising at least one of phosphonic acid, silanol or carboxylic acid.

16. A method of synthesizing a lubricant, comprising:
reacting a perfluorinated polyether with a halogenated functional group, wherein the functional group is phosphonic acid, silanol or carboxylic acid.

17. The method of claim 16, wherein the halogenated functional group is (2-bromethyl)phosphonic acid or 4-bromobenzylphosphonic acid,.

18. The method of claim 16, wherein the halogenated functional group is diethyl 2-bromoethylphosphonate or diethyl(4-brombenzyl)phosphonate.

19. The method of claim 16, wherein the halogenated functional group is (4-chlorophenyl)triethoxysilane or (4-bromphenyl)trimethoxysilane.

20. The method of claim 16, wherein the perfluorinated polyether is —CF₂O(CF₂CF₂CF₂CF₂O)ₙ—, —CF₂O(CF₂CF₂CF₂O)ₙCF₂—, —CF₂O[CF(CF₃)CF₂O]ₙCF₂—, —CF₂O(CF₂CF₂O)ₘ(CF₂O)ₙCF₂—, —CF₂O(CF₂CF₂O)ₙCF₂— and m, n are independently from 1 to 100.

21. The method of claim 17, wherein the perfluorinated polyether is —CF₂O(CF₂CF₂O)ₙCF₂—, and n is independently from 1 to 100.
